(19) United States
(12) Patent Application Publication
(10) Pub. No.: US 2026/0129633 A1
(43) Pub. Date: May 7, 2026

(54) POWER CONTROL USING PROBABILISTIC SHAPING

(71) Applicant: QUALCOMM Incorporated, San Diego, CA (US)

(72) Inventors: Wei YANG, San Diego, CA (US); Pinar SEN, San Diego, CA (US); Kirill IVANOV, La Jolla, CA (US)

(21) Appl. No.: 18/935,368

(22) Filed: Nov. 1, 2024

(51) Int. Cl. H04W 72/044

(52) U.S. Cl. CPC H04W 72/0473

(57) ABSTRACT

Methods, systems, and devices for wireless communication are described. A device (e.g., a UE or a network entity) may generate a first set of bits by performing a probabilistic shaping operation on first information bits using a first shaping parameter associated with a first layer and a second set of bits by performing the probabilistic shaping operation on second information bits using a second shaping parameter associated with a second layer. The device may generate a first set of symbols and a second set of symbols by modulating the first set of bits and the second set of bits using a modulation power scaling factor and transmit the first set of symbols via the first layer and the second set of symbols via the second layer.

### FIELD OF TECHNOLOGY

The following relates to wireless communication, including power control using probabilistic shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a device (e.g., a UE or a network entity) may implement a power control scheme to optimize power allocated to different layers (e.g., spatial layers) supported by the device.

### SUMMARY

The systems, methods, and devices of this disclosure each have several innovative aspects, no single one of which is solely responsible for the desirable attributes disclosed herein.

A method for wireless communications by a transmitting device is described. The method may include generating a first set of bits by performing a probabilistic shaping operation on first information bits, the probabilistic shaping operation using a first shaping parameter associated with a first layer, generating a second set of bits by performing the probabilistic shaping operation on second information bits, the probabilistic shaping operation using a second shaping parameter associated with a second layer to generate the second set of bits, the first shaping parameter being different than the second shaping parameter, generating a first set of symbols and a second set of symbols by modulating the first set of bits and the second set of bits using a modulation power scaling factor, the first set of symbols corresponding to the first set of bits and the second set of symbols corresponding to the second set of bits, and transmitting the first set of symbols via the first layer and the second set of symbols via the second layer.

A transmitting device for wireless communications is described. The transmitting device may include one or more memories storing processor executable code, and one or more processors coupled with the one or more memories. The one or more processors may individually or collectively be operable to execute the code to cause the transmitting device to generate a first set of bits by performing a probabilistic shaping operation on first information bits, the probabilistic shaping operation using a first shaping parameter associated with a first layer, generate a second set of bits by performing the probabilistic shaping operation on second information bits, the probabilistic shaping operation using a second shaping parameter associated with a second layer to generate the second set of bits, the first shaping parameter being different than the second shaping parameter, generate a first set of symbols and a second set of symbols by modulating the first set of bits and the second set of bits using a modulation power scaling factor, the first set of symbols corresponding to the first set of bits and the second set of symbols corresponding to the second set of bits, and transmit the first set of symbols via the first layer and the second set of symbols via the second layer.

Another transmitting device for wireless communications is described. The transmitting device may include means for generating a first set of bits by performing a probabilistic shaping operation on first information bits, the probabilistic shaping operation using a first shaping parameter associated with a first layer, means for generating a second set of bits by performing the probabilistic shaping operation on second information bits, the probabilistic shaping operation using a second shaping parameter associated with a second layer to generate the second set of bits, the first shaping parameter being different than the second shaping parameter, means for generating a first set of symbols and a second set of symbols by modulating the first set of bits and the second set of bits using a modulation power scaling factor, the first set of symbols corresponding to the first set of bits and the second set of symbols corresponding to the second set of bits, and means for transmitting the first set of symbols via the first layer and the second set of symbols via the second layer.

A non-transitory computer-readable medium storing code for wireless communications is described. The code may include instructions executable by one or more processors to generate a first set of bits by performing a probabilistic shaping operation on first information bits, the probabilistic shaping operation using a first shaping parameter associated with a first layer, generate a second set of bits by performing the probabilistic shaping operation on second information bits, the probabilistic shaping operation using a second shaping parameter associated with a second layer to generate the second set of bits, the first shaping parameter being different than the second shaping parameter, generate a first set of symbols and a second set of symbols by modulating the first set of bits and the second set of bits using a modulation power scaling factor, the first set of symbols corresponding to the first set of bits and the second set of symbols corresponding to the second set of bits, and transmit the first set of symbols via the first layer and the second set of symbols via the second layer.

### BRIEF DESCRIPTION OF THE DRAWINGS

FIG. 1 shows an example of a wireless communications system that supports power control using probabilistic shaping in accordance with one or more aspects of the present disclosure.

FIG. 2 shows an example of a wireless communications system that supports power control using probabilistic shaping in accordance with one or more aspects of the present disclosure.

FIG. 3 shows an example of a process flow that supports power control using probabilistic shaping in accordance with one or more aspects of the present disclosure.

FIGS. 4 and 5 show block diagrams of devices that support power control using probabilistic shaping in accordance with one or more aspects of the present disclosure.

FIG. 6 shows a block diagram of a communications manager that supports power control using probabilistic shaping in accordance with one or more aspects of the present disclosure.

FIG. 7 shows a diagram of a system including a UE that supports power control using probabilistic shaping in accordance with one or more aspects of the present disclosure.

FIG. 8 shows a diagram of a system including a network entity that supports power control using probabilistic shaping in accordance with one or more aspects of the present disclosure.

FIGS. 9 and 10 show flowcharts illustrating methods that support power control using probabilistic shaping in accordance with one or more aspects of the present disclosure.

### DETAILED DESCRIPTION

Devices of a wireless communications system may support a power control scheme known as water-filling. Water-filling may allow a device to optimize power allocated to different layers supported by the device (e.g., MIMO spatial layers). However, the use of water-filling for power control in some wireless communications systems may be impractical. For example, in order to realize the advantages of power control via water-filling, the device may adapt a modulation order to different layers which may be difficult to implement in some wireless communications system. Alternatively, if a same modulation order is used for all layers, the capacity of the layers with better channel conditions may saturate at the modulation order rendering the water-filling power control scheme less useful. Further, layers with smaller power may have large bit-interleaved coded modulation (BICM) performance losses.

As described herein, devices of the wireless communications system may support power control via probabilistic shaping. Probabilistic shaping may allow a device to convert uniformly distributed information bits into non-uniformly distributed information bits. Thus, through probabilistic shaping, the device may change a probability at which different symbols are transmitted from the device. For example, the device may change the distribution of the information bits such that higher power symbols are transmitted at a lower probability when compared to lower power symbols to reduce overall power consumption of the device.

Thus, using probabilistic shaping, the device may change an entropy and a power associated with symbols transmitted from the device. As described herein, during probabilistic shaping, the device may generate a first set of bits and a second set of bits from information bits using a respective shaping parameter that corresponds to a layer supported by the device. Upon generating the first set of bits and the second set of bits, the transmitting device may modulate the first set of bits and the second set of bits to generate a first set of symbols and a second set of symbols using a same modulation power scaling factor. As a result, layers with smaller shaping parameters may have more entropy and more power when compared to layers with larger shaping parameters.

Aspects of the disclosure are initially described in the context of wireless communications systems. Additional aspects are described in the context of a process flow. Aspects of the disclosure are further illustrated by and described with reference to apparatus diagrams, system diagrams, and flowcharts that relate to power control using probabilistic shaping.

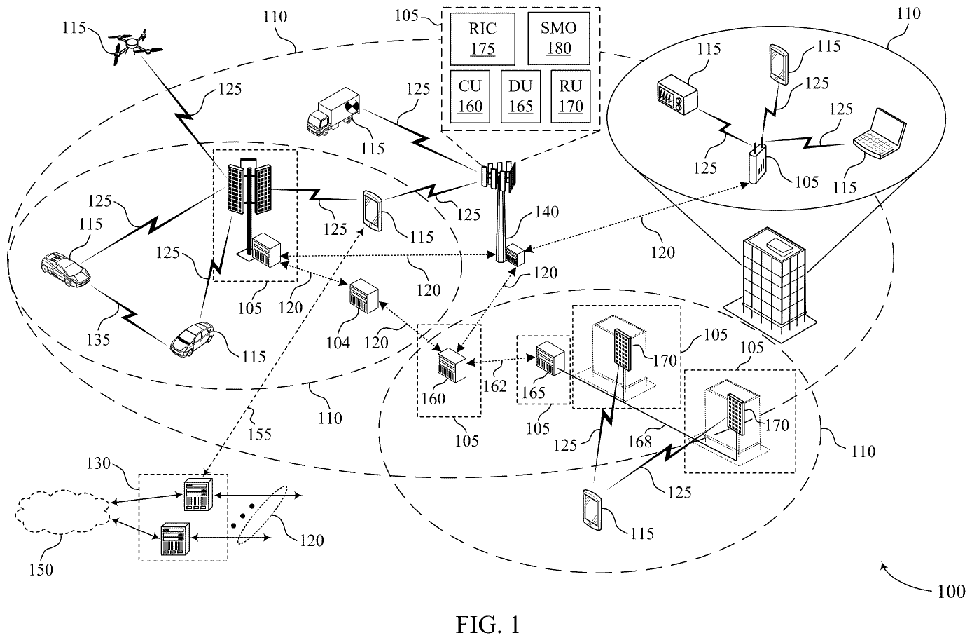

FIG. 1 shows an example of a wireless communications system 100 that supports power control using probabilistic shaping in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support power control using probabilistic shaping as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a device of the wireless communications system 100 (e.g., a UE 115 or a network entity 105) may support power control via probabilistic shaping. In some examples, the device may generate a first set of bits by performing a probabilistic shaping operation on first information bits using a first shaping parameter of a first layer and a second set of bits by performing the probabilistic shaping operation on second information bits using a second shaping parameter of a second layer. The wireless device may then generate a first set of symbols and a second set of symbols by modulating the first set of bits and the second set of bits using a same modulation power scaling factor. The first set of symbols and the second set of symbols may correspond to the first set of bits and the second set of bits, respectively.

Upon generating the first set of symbols and the second set of symbols, the device may transmit the first set of symbols via the first layer and the second set of symbols via the second layer. Using the methods as described herein may allow the device to implement power control at a bit domain as opposed to manipulating transmit power which may reduce complexity of the device. Further, the methods as described herein may be implemented with less signaling than other power control methods thereby reducing signaling overhead at the device.

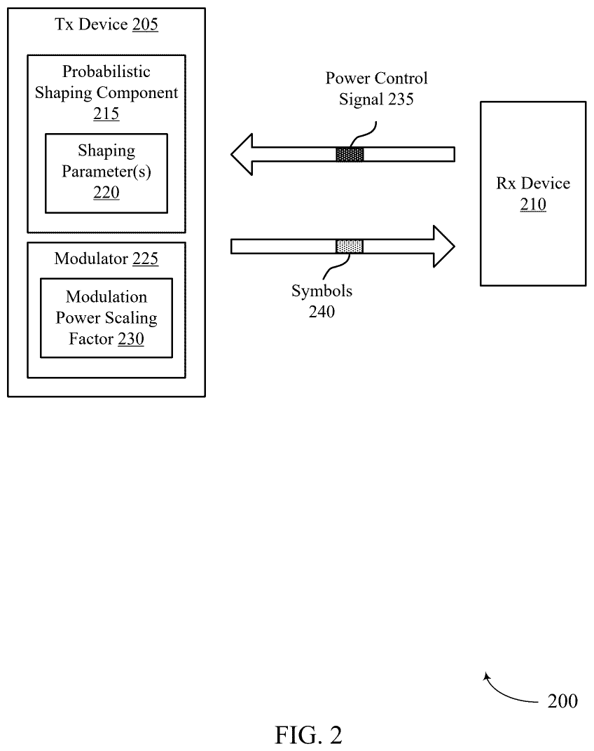

FIG. 2 shows an example of a wireless communications system 200 that supports power control using probabilistic shaping in accordance with one or more aspects of the present disclosure. In some examples, the wireless communications system 200 may implement aspects of the wireless communications system 100. For example, the wireless communications system 200 may include a transmitting device 205 and a receiving device 210 each of which may be an example of the UE 115 or the network entity 105 as described with reference to FIG. 1.

In some examples, the wireless communications system 200 may support MIMO communication. MIMO communication may allow the transmitting device 205 to transmit two or more streams of data to the receiving device 210 via overlapping time and frequency resources using two or more spatial layers. As an example, the transmitting device 205 may transmit a first stream of data via a first set of resources using a first spatial layer and a second stream of data via a second set of resources that at least partially overlaps the first set of resources in time and frequency using a second spatial layer. In some examples, the two or more streams of data may include duplicate data. Alternatively, the two or more streams of data may include unique data.

In some examples, different spatial layer may be associated with different channels gains. As such, it may be beneficial to allocate power differently to each of the different spatial layers. One way to control the power allocated to each of the spatial layers may be known as water-filling. Water-filling is a method in which the transmitting device 205 may allocate a different amount of power to different spatial layers based on gain associated with the different spatial layers. For example, using a water-filling algorithm, the transmitting device 205 may allocate more power to spatial layers with the most favorable signal-to-noise ratio (SNR).

But, water-filling may not be practical for wireless communications systems that support MIMO communication. To unleash the gain of water-filling, the transmitting device 205 may adapt a modulation order applied to the different spatial layers which may be impractical for some wireless communications systems. As another option, the transmitting device 205 may apply a same modulation order across all the spatial layers, but as a consequence, a capacity of the spatial layers with better channel conditions may saturate at the modulation order rendering the water-filling useless and the spatial layers with smaller power may have large bit interleaved coded modulation (BICM) performance losses.

In some examples, the transmitting device 205 may support probabilistic shaping. To prepare information bits for transmission, the transmitting device 205 may translate the information bits into symbols of a constellation. In some examples, each symbol of the constellation may be associated with a different phase and amplitude combination. Symbols with smaller amplitudes may be transmitted with less power and may be located in the center of the constellation, whereas symbols with larger amplitudes may be transmitted with more power and may be located near the edges of the constellation. In some examples, the information bits may be uniformly distributed causing the transmitting device 205 to generate the symbols of the constellation with equal probability. However, transmitting smaller amplitude symbols at the same probability as larger amplitude symbols may increase power consumption at the transmitting device 205.

In some examples, to reduce power consumption, the transmitting device 205 may implement probabilistic shaping. Probabilistic shaping may allow the transmitting device 205 to convert the uniformly distributed information bits into non-uniformly distributed information bits such that smaller amplitude symbols are transmitted at an increased probability when compared to smaller amplitude symbols. In some examples, the transmitting device 205 may target a Maxwell-Boltzmann (MB) distribution as represented by Equation 1.

In Equation 1, v may represent a shaping parameter and may influence characteristics (e.g., spread and peak) of the probability distribution, X may represent a modulation symbol which takes a value in a fixed constellation symbol set (e.g., a fixed constellation symbol set of S={s₁, s₂, . . . , s_{M}}, where M denotes the number of points in the constellation), and |X|² may represent the power of the constellation symbol (e.g., X). According to Equation 1, the probability of using a symbol in the modulation constellation should be proportional to the exponential function e^{-v|X|2}. The transmitting device 205 may utilize multiple coding schemes to achieve the desired probability distribution. For example, the transmitting device 205 may implement source coding techniques (e.g., arithmetic coding, Huffman coding, constant-composition distribution matching (CCDM), or multi-composition distribution matching (MCDM)) or channel coding techniques (e.g., polar code, low density parity check (LDPC) code, or trellis code).

$$p ( X ) ∼ {e}^{- v \vert X {\vert}^{2}} \qquad ( 1 )$$

A consequence of changing the distribution from uniform to non-uniform may be a change in average transmit power and entropy (e.g., actual information perceived by the receiving device 210). For example, changing the distribution from uniform to non-uniform may cause the average transmit power to decrease as well as the average entropy. In fact, there may be a linear relationship between the power and the entropy. In some examples, because the average transmit power may change, the transmitting device 205 may normalize the average transmit power to one.

To normalize the average transmit power to one, the transmitting device 205 may apply a modulation power scaling factor which scales a magnitude of the modulated symbols such that the resulting average transmit power is equal to a value (e.g., a value of one). Equation 2 is an example of an equation used by the transmitting device 205 to calculate the modulation power scaling factor (or n) for a uniform distribution. In Equation 2, E [|X|²] may represent an average transmit power of the set of symbols (e.g., taken from S={s₁, s₂, . . . , s_{M}}). The transmitting device 205 may apply the modulation power scaling factor to each of the symbols (e.g., X) as illustrated in Equation 3 to generate a modulation power scaled symbol (e.g., X*).

$$η = 1 / E [ {\vert X \vert}^{2} ] \qquad ( 2 )$$

$${X}^{*} = X * \sqrt{η} \qquad ( 3 )$$

As described herein, the wireless communications system 200 may utilize probabilistic shaping as a power control technique for MIMO communication. As shown in FIG. 2, the transmitting device 205 may include a probabilistic shaping component 215 and a modulator 225. In some examples, the transmitting device 205 may identify a shaping parameter 220 for each layer. For example, the transmitting device 205 may identify a first shaping parameter 220 for a first layer and a second shaping parameter 220 for a second layer.

In some examples, the transmitting device 205 may receive a power control signal 235 indicating the shaping parameter 220 for each layer. In some examples, a shaping parameter 220 for a layer may depend on a condition of a channel associated with the layer. Further, a shaping parameter 220 for a layer may be indicative of an entropy associated with the layer. For example, the first shaping parameter 220 for the first layer may be smaller than the second shaping parameter 220 for the second layer indicating that an entropy associated with the first layer is larger than an entropy associated with the second layer.

In some examples, the transmitting device 205 may have information bits to send to the receiving device 210. The information bits may include first information bits and second information bits. Using the probabilistic shaping component 215, the transmitting device 205 may generate a first set of bits by performing a probabilistic shaping operation on the first information bits using the first shaping parameter 220. Further, using the probabilistic shaping component 215, the transmitting device 205 may generate a second set of bits by performing the probabilistic operation on the second information bits using the second shaping parameter 220.

Upon generating the first set of bits and the second set of bits, the transmitting device 205 may utilize the modulator 225 to modulate the first set of bits and the second set of bits. Modulating the first set of bits may include generating a first set of symbols and applying modulation power scaling factor 230 to the first set of symbols. Modulating the second set of bits may include generating a second set of symbols and applying the same modulation power scaling factor 230 to the second set of symbols.

In some examples, prior to modulation, the transmitting device 205 may identify the modulation power scaling factor 230 to apply to the first set of symbols and the second set of symbols. In a first example, the transmitting device 205 may select the modulation power scaling factor 230 corresponding to the strongest layer or the layer with the largest entropy. For example, the transmitting device 205 may select modulation power scaling factor 230 that normalizes an average power associated with the first set of symbols for the first layer (to a value of one). In a second example, the transmitting device 205 may select the modulation power scaling factor 230 corresponding to the weakest layer or the layer with the smallest entropy. For example, the transmitting device 205 may select a modulation power scaling factor 230 that normalizes an average power associated with the second set of symbols for the second layer (to a value of one).

In a third example, the transmitting device 205 may select the modulation power scaling factor 230 that corresponds to the modulation scheme supported by the transmitting device 205. For example, the transmitting device 205 may select a modulation power scaling factor of 140 if the transmitting device supports 256 QAM. In some examples, prior to modulation, the transmitting device 205 may receive signaling (e.g., the power control signal 235) that indicates a modulation power scaling factor 230 for each modulation scheme configured for the transmitting device 205. In a fourth example, the transmitting device 205 may select the modulation power scaling factor 230 that normalizes an average power or a summation of power associated with the first set of symbols and the second set of symbols. Equations 4 and 5 illustrate an example of equations that may be used to determine the modulation power scaling factor 230 in the fourth example. In Equations 4 and 5, L may represent a quantity of layers.

$${\sum }_{l = 1}^{L} {E}_{{v}_{l}} [ {\vert X \vert}^{2} ] \cdot η = 1 \qquad ( 4 )$$

$${\sum }_{l = 1}^{L} {E}_{{v}_{l}} [ {\vert X \vert}^{2} ] \cdot η = L \qquad ( 5 )$$

In some examples, upon generating the symbols 240 (e.g., first set of symbols and the second set of symbols), the transmitting device 205 may transmit the symbols 240 to the receiving device 210 using two or more layers. For example, the transmitting device 205 may transmit the first set of symbols using the first layer and the second set of symbols using the second layer. By utilizing the methods as described herein, the wireless communications system 200 may implement shaping gains as well as power control gains. Further, power control via probabilistic shaping may be done in the bit domain as opposed to manipulating transmit power which may reduce complexity when compared to other methods.

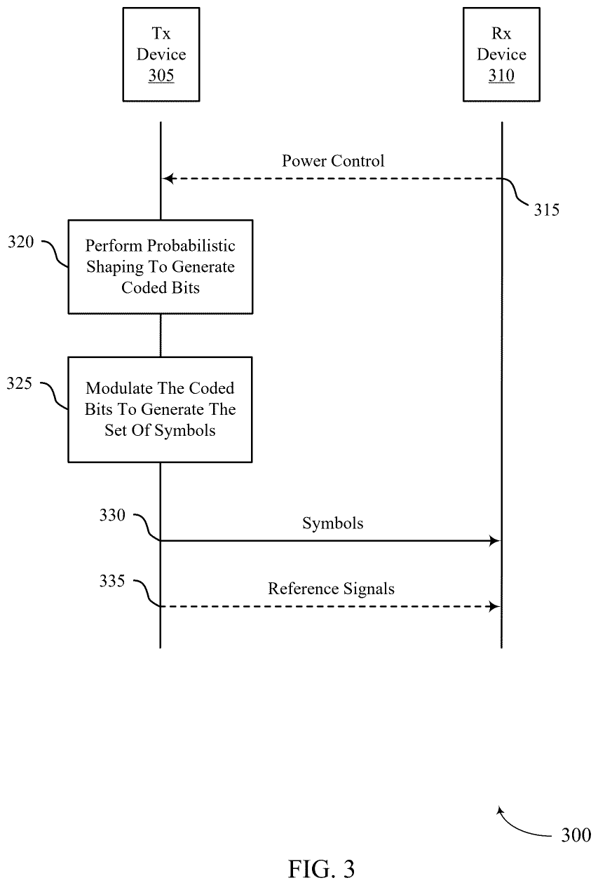

FIG. 3 shows an example of a process flow 300 that supports power control using probabilistic shaping in accordance with one or more aspects of the present disclosure. In some examples, aspects of the wireless communications system 100 and the wireless communications system 200 may implement or be implemented by the process flow 300. For example, the process flow 300 may implement or be implemented by the UE 115 or the network entity 105 as described with reference to FIG. 1. Additionally, or alternatively, the process flow 300 may implement or be implemented by the transmitting device 205 or the receiving device 210 as described with reference to FIG. 2. Alternative examples of the following may be implemented, where some steps are performed in a different order then described or are not performed at all. In some cases, steps may include additional features not mentioned below, or further steps may be added.

At 315, the receiving device 310 may optionally transmit a power control signal to the transmitting device 305. In some examples, the power control signal may indicate a shaping parameter for each layer supported by the transmitting device 305. For example, the power control signal may indicate that a first shaping parameter corresponds a first layer supported by the transmitting device 305 and a second shaping parameter corresponds to a second layer supported by the transmitting device 305. In some examples, the transmitting device 305 may support MIMO communication and the layers may be examples of spatial layers used for MIMO communication. In another example, the layers may be examples of different sub-bands supported by the transmitting device 305. In some examples, both the transmitting device 305 and the receiving device 310 may have knowledge of the first shaping parameter and the second shaping parameter (e.g., via signaling to and from one another).

At 320, the transmitting device 305 may perform a probabilistic shaping operation. For example, the transmitting device 305 may generate a first set of bits by performing the probabilistic shaping operation on first information bits using the first shaping parameter. Additionally, or alternatively, the transmitting device 305 may generate a second set of bits by performing the probabilistic shaping operation on second information bits using the second shaping parameter. In some examples, the first shaping parameter is different than the second shaping parameter.

At 325, the transmitting device 305 may modulate the first set of bits to generate a first set of symbols and the second set of bits to generate a second set of symbols. In some examples, the transmitting device 305 may identify a modulation power scaling factor and use the modulation power scaling factor (e.g., a same modulation power scaling factor) during modulation of the first set of bits and the second set of bits. In one example, the transmitting device 305 may identify the modulation power scaling factor based on an entropy associated with the first layer being greater than an entropy associated with the second layer. In such example, the modulation power scaling factor may normalize an average power associated with the first set of symbols for the first layer.

Alternatively, the transmitting device 305 may identify the modulation power scaling factor based on the entropy associated with the second layer being less than the entropy associated with the first layer. In such example, the modulation power scaling factor may normalize an average power associated with the second set of symbols for the second layer.

Alternatively, the transmitting device 305 may select the modulation power scaling factor such that the modulation power scaling factor normalizes an average power or a summation of power associated with the first set of symbols and the second set of symbols.

Alternatively, the transmitting device 305 may select the modulation power scaling factor that corresponds to a modulation order configured for the transmitting device 305. In all cases, a same power modulation scaling factor may be applied to the different layers.

At 330, the transmitting device 305 may transmit the first set of symbols via the first layer and the second set of symbols via the second layer to the receiving device 310. In some examples, the transmitting device 305 may transmit the first set of symbols using a first power level (e.g., a first average transmit power) and the second set of symbols using a second power level (e.g., a second average transmit power). In some examples, upon receiving the first set of symbols and the second set of symbols, the receiving device may utilize the first shaping parameter and the second shaping parameter to demodulate and deshape the first set of symbols and the second set of symbols.

At 335, the transmitting device 305 may optionally transmit reference signals to the receiving device 310. In some examples, the transmitting device 305 may transmit a first set of reference signals via the first layer using a power level that is within a threshold value of the first power level or the same as the first power level. Additionally, the transmitting device 305 may transmit a second set of reference signals via the second layer using a power level that is within a threshold value of the second power level or is the same as the second power level. Alternatively, the transmitting device 305 may transmit the first set of reference signals via the first layer and the second set of reference signals via the second layer using a same power level. In some examples, the power level may be based on an average of the first power level and the second power level. In some examples, the reference signals may include two or more DMRSs or two or more PTRSs.

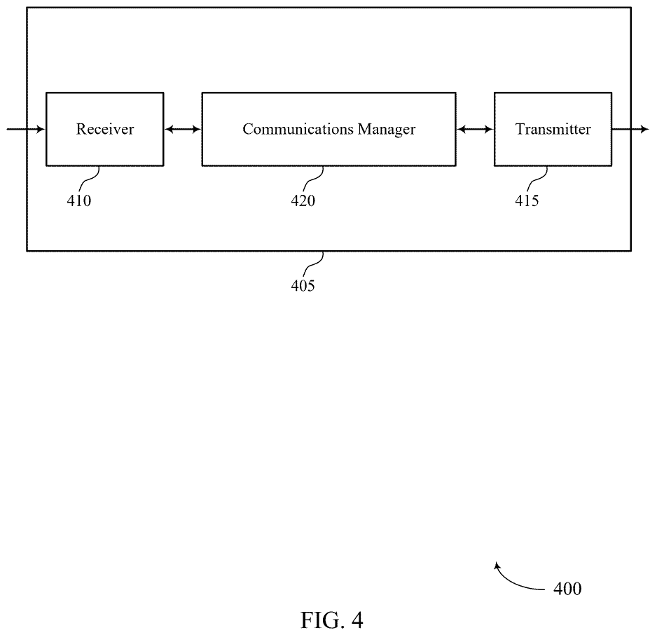

FIG. 4 shows a block diagram 400 of a device 405 that supports power control using probabilistic shaping in accordance with one or more aspects of the present disclosure. The device 405 may be an example of aspects of a UE 115 or a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to power control using probabilistic shaping). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to power control using probabilistic shaping). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of power control using probabilistic shaping as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for generating a first set of bits by performing a probabilistic shaping operation on first information bits, the probabilistic shaping operation using a first shaping parameter associated with a first layer. The communications manager 420 is capable of, configured to, or operable to support a means for generating a second set of bits by performing the probabilistic shaping operation on second information bits, the probabilistic shaping operation using a second shaping parameter associated with a second layer to generate the second set of bits, the first shaping parameter being different than the second shaping parameter. The communications manager 420 is capable of, configured to, or operable to support a means for generating a first set of symbols and a second set of symbols by modulating the first set of bits and the second set of bits using a modulation power scaling factor, the first set of symbols corresponding to the first set of bits and the second set of symbols corresponding to the second set of bits. The communications manager 420 is capable of, configured to, or operable to support a means for transmitting the first set of symbols via the first layer and the second set of symbols via the second layer.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption.

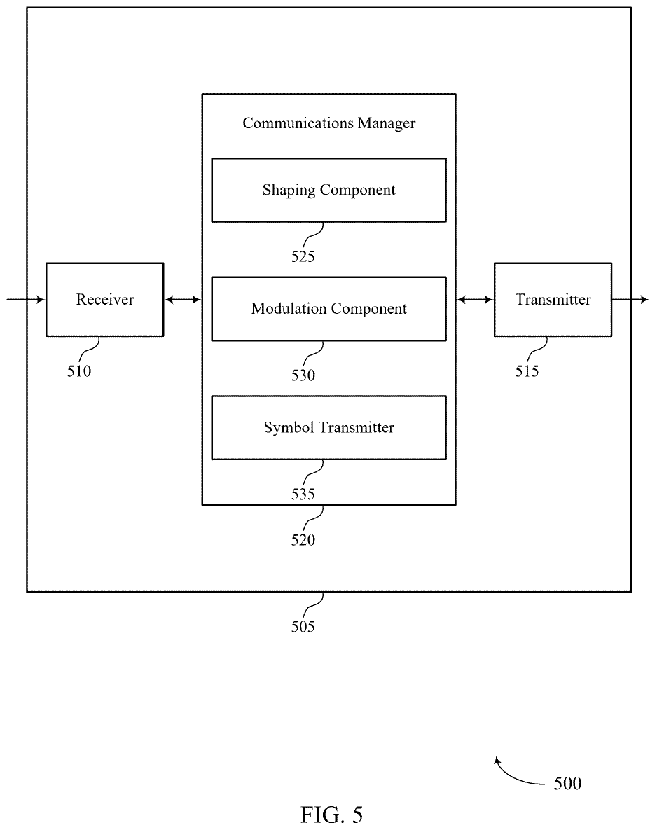

FIG. 5 shows a block diagram 500 of a device 505 that supports power control using probabilistic shaping in accordance with one or more aspects of the present disclosure. The device 505 may be an example of aspects of a device 405, a UE 115, or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to power control using probabilistic shaping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power control using probabilistic shaping). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of power control using probabilistic shaping as described herein. For example, the communications manager 520 may include a shaping component 525, a modulation component 530, a symbol transmitter 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The shaping component 525 is capable of, configured to, or operable to support a means for generating a first set of bits by performing a probabilistic shaping operation on first information bits, the probabilistic shaping operation using a first shaping parameter associated with a first layer. The shaping component 525 is capable of, configured to, or operable to support a means for generating a second set of bits by performing the probabilistic shaping operation on second information bits, the probabilistic shaping operation using a second shaping parameter associated with a second layer to generate the second set of bits, the first shaping parameter being different than the second shaping parameter. The modulation component 530 is capable of, configured to, or operable to support a means for generating a first set of symbols and a second set of symbols by modulating the first set of bits and the second set of bits using a modulation power scaling factor, the first set of symbols corresponding to the first set of bits and the second set of symbols corresponding to the second set of bits. The symbol transmitter 535 is capable of, configured to, or operable to support a means for transmitting the first set of symbols via the first layer and the second set of symbols via the second layer.

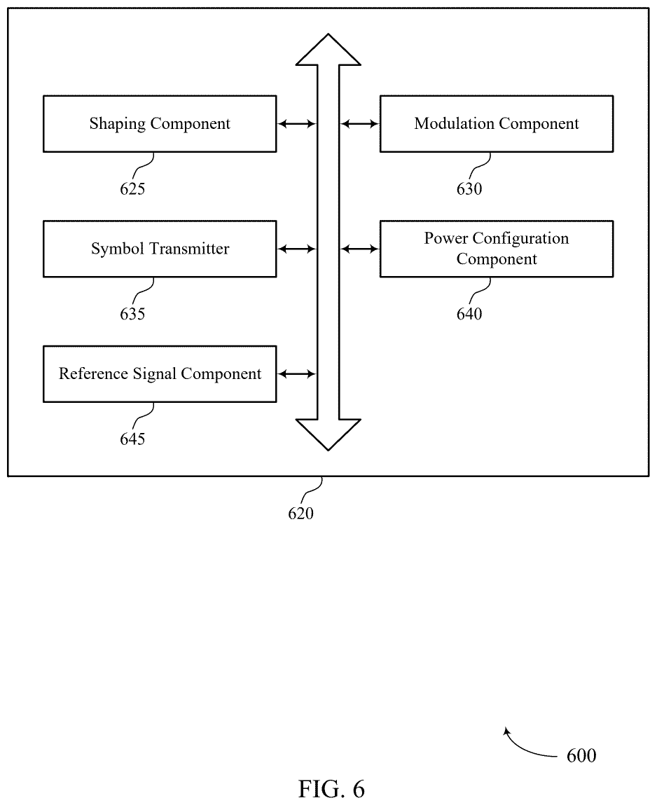

FIG. 6 shows a block diagram 600 of a communications manager 620 that supports power control using probabilistic shaping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of power control using probabilistic shaping as described herein. For example, the communications manager 620 may include a shaping component 625, a modulation component 630, a symbol transmitter 635, a power configuration component 640, a reference signal component 645, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communications in accordance with examples as disclosed herein. The shaping component 625 is capable of, configured to, or operable to support a means for generating a first set of bits by performing a probabilistic shaping operation on first information bits, the probabilistic shaping operation using a first shaping parameter associated with a first layer. In some examples, the shaping component 625 is capable of, configured to, or operable to support a means for generating a second set of bits by performing the probabilistic shaping operation on second information bits, the probabilistic shaping operation using a second shaping parameter associated with a second layer to generate the second set of bits, the first shaping parameter being different than the second shaping parameter. The modulation component 630 is capable of, configured to, or operable to support a means for generating a first set of symbols and a second set of symbols by modulating the first set of bits and the second set of bits using a modulation power scaling factor, the first set of symbols corresponding to the first set of bits and the second set of symbols corresponding to the second set of bits. The symbol transmitter 635 is capable of, configured to, or operable to support a means for transmitting the first set of symbols via the first layer and the second set of symbols via the second layer.

In some examples, performing the probabilistic shaping operation on the first information bits results in the first set of symbols having a non-uniformly distributed constellation. In some examples, the power configuration component 640 is capable of, configured to, or operable to support a means for receiving signaling indicating that the first shaping parameter corresponds to the first layer and the second shaping parameter corresponds to the second layer.

In some examples, to support generating the first set of symbols using the modulation power scaling factor, the modulation component 630 is capable of, configured to, or operable to support a means for identifying the modulation power scaling factor based on an entropy associated with the first layer being greater than an entropy associated the second layer, where the modulation power scaling factor normalizes an average power associated with the first set of symbols for the first layer.

In some examples, to support generating the second set of symbols using the modulation power scaling factor, the modulation component 630 is capable of, configured to, or operable to support a means for identifying the modulation power scaling factor based on an entropy associated with the second layer being less than an entropy associated with the first layer, where the modulation power scaling factor normalize an average power associated with the second set of symbols for the second layer.

In some examples, the modulation power scaling factor normalizes an average power or a summation of power associated with the first set of symbols and the second set of symbols. In some examples, the modulation power scaling factor is based on a modulation order configured for the transmitting device.

In some examples, the reference signal component 645 is capable of, configured to, or operable to support a means for transmitting a first set of multiple reference signals via the first layer using a power level that is based on a power level associated with the first set of symbols. In some examples, the reference signal component 645 is capable of, configured to, or operable to support a means for transmitting a second set of multiple reference signals via the second layer using a power level that is based on a power level associated with the second set of symbols.

In some examples, the first set of multiple reference signals and the second set of multiple reference signals include demodulation reference signals or phase tracking reference signals. In some examples, the first layer includes a first spatial layer of a MIMO communication scheme and the second layer includes a second spatial layer of the MIMO communication scheme. In some examples, the first layer includes a first subband and the second layer includes a second subband.

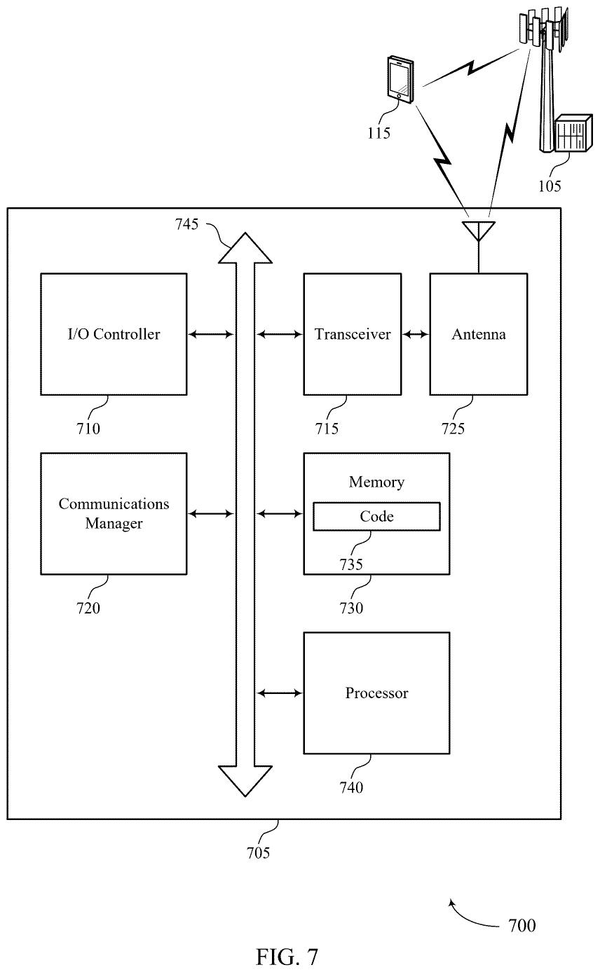

FIG. 7 shows a diagram of a system 700 including a device 705 that supports power control using probabilistic shaping in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting power control using probabilistic shaping). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for generating a first set of bits by performing a probabilistic shaping operation on first information bits, the probabilistic shaping operation using a first shaping parameter associated with a first layer. The communications manager 720 is capable of, configured to, or operable to support a means for generating a second set of bits by performing the probabilistic shaping operation on second information bits, the probabilistic shaping operation using a second shaping parameter associated with a second layer to generate the second set of bits, the first shaping parameter being different than the second shaping parameter. The communications manager 720 is capable of, configured to, or operable to support a means for generating a first set of symbols and a second set of symbols by modulating the first set of bits and the second set of bits using a modulation power scaling factor, the first set of symbols corresponding to the first set of bits and the second set of symbols corresponding to the second set of bits. The communications manager 720 is capable of, configured to, or operable to support a means for transmitting the first set of symbols via the first layer and the second set of symbols via the second layer.

By including or configuring the communications manager 720 in accordance with examples as described herein, the device 705 may support techniques for reduced power consumption and reduced signaling overhead.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of power control using probabilistic shaping as described herein, or the at least one processor 740 and the at least one memory 730 may be otherwise configured to, individually or collectively, perform or support such operations.

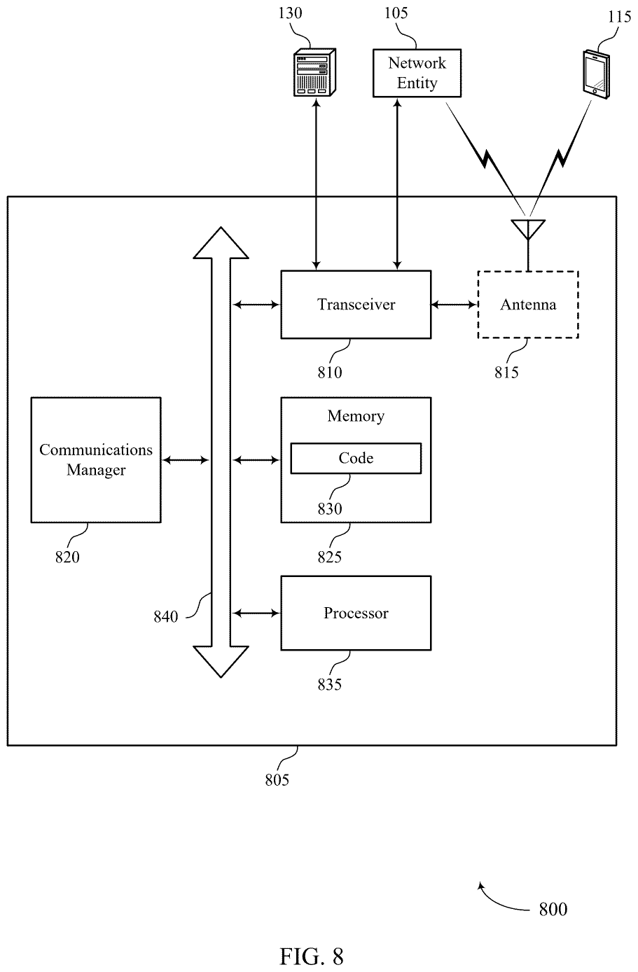

FIG. 8 shows a diagram of a system 800 including a device 805 that supports power control using probabilistic shaping in accordance with one or more aspects of the present disclosure. The device 805 may be an example of or include components of a device 405, a device 505, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting power control using probabilistic shaping). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for generating a first set of bits by performing a probabilistic shaping operation on first information bits, the probabilistic shaping operation using a first shaping parameter associated with a first layer. The communications manager 820 is capable of, configured to, or operable to support a means for generating a second set of bits by performing the probabilistic shaping operation on second information bits, the probabilistic shaping operation using a second shaping parameter associated with a second layer to generate the second set of bits, the first shaping parameter being different than the second shaping parameter. The communications manager 820 is capable of, configured to, or operable to support a means for generating a first set of symbols and a second set of symbols by modulating the first set of bits and the second set of bits using a modulation power scaling factor, the first set of symbols corresponding to the first set of bits and the second set of symbols corresponding to the second set of bits. The communications manager 820 is capable of, configured to, or operable to support a means for transmitting the first set of symbols via the first layer and the second set of symbols via the second layer.

By including or configuring the communications manager 820 in accordance with examples as described herein, the device 805 may support techniques reduced power consumption and reduced signaling overhead.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of power control using probabilistic shaping as described herein, or the at least one processor 835 and the at least one memory 825 may be otherwise configured to, individually or collectively, perform or support such operations.

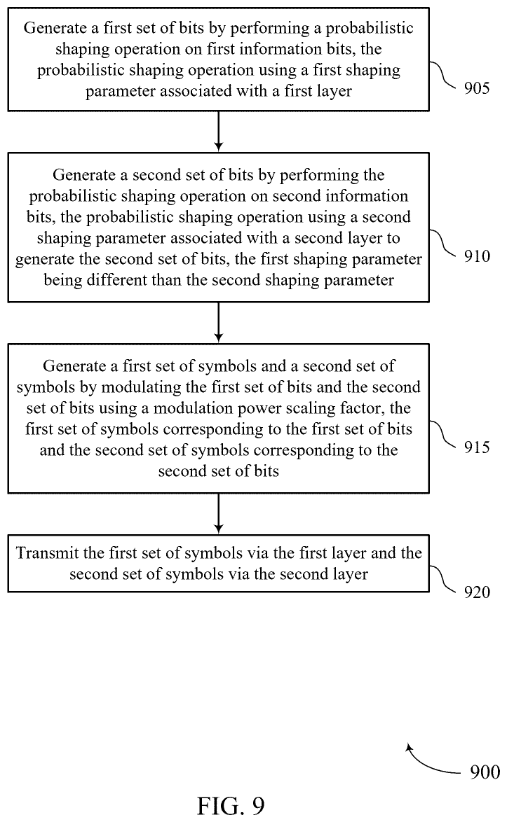

FIG. 9 shows a flowchart illustrating a method 900 that supports power control using probabilistic shaping in accordance with one or more aspects of the present disclosure. The operations of the method 900 may be implemented by a UE or a network entity or its components as described herein. For example, the operations of the method 900 may be performed by a UE 115 or a network entity as described with reference to FIGS. 1 through 8. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 905, the method may include generating a first set of bits by performing a probabilistic shaping operation on first information bits, the probabilistic shaping operation using a first shaping parameter associated with a first layer. The operations of 905 may be performed in accordance with examples as disclosed herein. In some examples, aspects of the operations of 905 may be performed by a shaping component 625 as described with reference to FIG. 6.

At 910, the method may include generating a second set of bits by performing the probabilistic shaping operation on second information bits, the probabilistic shaping operation using a second shaping parameter associated with a second layer to generate the second set of bits, the first shaping parameter being different than the second shaping parameter. The operations of 910 may be performed in accordance with examples as disclosed herein. In some examples, aspects of the operations of 910 may be performed by a shaping component 625 as described with reference to FIG. 6.

At 915, the method may include generating a first set of symbols and a second set of symbols by modulating the first set of bits and the second set of bits using a modulation power scaling factor, the first set of symbols corresponding to the first set of bits and the second set of symbols corresponding to the second set of bits. The operations of 915 may be performed in accordance with examples as disclosed herein. In some examples, aspects of the operations of 915 may be performed by a modulation component 630 as described with reference to FIG. 6.

At 920, the method may include transmitting the first set of symbols via the first layer and the second set of symbols via the second layer. The operations of 920 may be performed in accordance with examples as disclosed herein. In some examples, aspects of the operations of 920 may be performed by a symbol transmitter 635 as described with reference to FIG. 6.

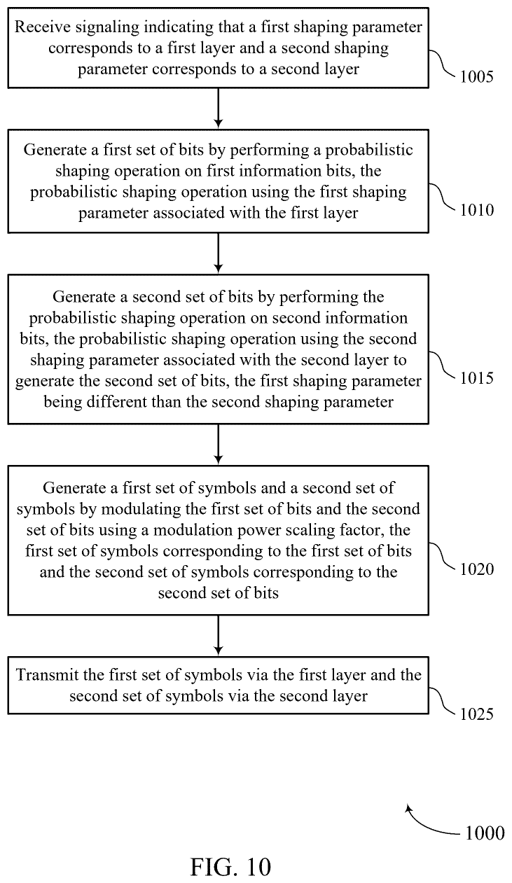

FIG. 10 shows a flowchart illustrating a method 1000 that supports power control using probabilistic shaping in accordance with one or more aspects of the present disclosure. The operations of the method 1000 may be implemented by a UE or a network entity or its components as described herein. For example, the operations of the method 1000 may be performed by a UE 115 or a network entity as described with reference to FIGS. 1 through 8. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include receiving signaling indicating that a first shaping parameter corresponds to a first layer and a second shaping parameter corresponds to a second layer. The operations of 1005 may be performed in accordance with examples as disclosed herein. In some examples, aspects of the operations of 1005 may be performed by a power configuration component 640 as described with reference to FIG. 6.

At 1010, the method may include generating a first set of bits by performing a probabilistic shaping operation on first information bits, the probabilistic shaping operation using the first shaping parameter associated with the first layer. The operations of 1010 may be performed in accordance with examples as disclosed herein. In some examples, aspects of the operations of 1010 may be performed by a shaping component 625 as described with reference to FIG. 6.

At 1015, the method may include generating a second set of bits by performing the probabilistic shaping operation on second information bits, the probabilistic shaping operation using the second shaping parameter associated with the second layer to generate the second set of bits, the first shaping parameter being different than the second shaping parameter. The operations of 1015 may be performed in accordance with examples as disclosed herein. In some examples, aspects of the operations of 1015 may be performed by a shaping component 625 as described with reference to FIG. 6.

At 1020, the method may include generating a first set of symbols and a second set of symbols by modulating the first set of bits and the second set of bits using a modulation power scaling factor, the first set of symbols corresponding to the first set of bits and the second set of symbols corresponding to the second set of bits. The operations of 1020 may be performed in accordance with examples as disclosed herein. In some examples, aspects of the operations of 1020 may be performed by a modulation component 630 as described with reference to FIG. 6.

At 1025, the method may include transmitting the first set of symbols via the first layer and the second set of symbols via the second layer. The operations of 1025 may be performed in accordance with examples as disclosed herein. In some examples, aspects of the operations of 1025 may be performed by a symbol transmitter 635 as described with reference to FIG. 6.

The following provides an overview of aspects of the present disclosure:
Aspect 1: A method for wireless communications at a transmitting device, comprising: generating a first set of bits by performing a probabilistic shaping operation on first information bits, the probabilistic shaping operation using a first shaping parameter associated with a first layer; generating a second set of bits by performing the probabilistic shaping operation on second information bits, the probabilistic shaping operation using a second shaping parameter associated with a second layer to generate the second set of bits, the first shaping parameter being different than the second shaping parameter; generating a first set of symbols and a second set of symbols by modulating the first set of bits and the second set of bits using a modulation power scaling factor, the first set of symbols corresponding to the first set of bits and the second set of symbols corresponding to the second set of bits; and transmitting the first set of symbols via the first layer and the second set of symbols via the second layer.
Aspect 2: The method of aspect 1, wherein performing the probabilistic shaping operation on the first information bits results in the first set of symbols having a non-uniformly distributed constellation.
Aspect 3: The method of any of aspects 1 through 2, further comprising: receiving signaling indicating that the first shaping parameter corresponds to the first layer and the second shaping parameter corresponds to the second layer.
Aspect 4: The method of any of aspects 1 through 3, wherein generating the first set of symbols using the modulation power scaling factor comprises: identifying the modulation power scaling factor based at least in part on an entropy associated with the first layer being greater than an entropy associated the second layer, wherein the modulation power scaling factor normalizes an average power associated with the first set of symbols for the first layer.
Aspect 5: The method of any of aspects 1 through 4, wherein generating the second set of symbols using the modulation power scaling factor comprises: identifying the modulation power scaling factor based at least in part on an entropy associated with the second layer being less than an entropy associated with the first layer, wherein the modulation power scaling factor normalize an average power associated with the second set of symbols for the second layer.
Aspect 6: The method of any of aspects 1 through 5, wherein the modulation power scaling factor normalizes an average power or a summation of power associated with the first set of symbols and the second set of symbols.
Aspect 7: The method of any of aspects 1 through 6, wherein the modulation power scaling factor is based on a modulation order configured for the transmitting device.
Aspect 8: The method of any of aspects 1 through 7, further comprising: transmitting a first plurality of reference signals via the first layer using a power level that is based on a power level associated with the first set of symbols; and transmitting a second plurality of reference signals via the second layer using a power level that is based on a power level associated with the second set of symbols.
Aspect 9: The method of aspect 8, wherein the first plurality of reference signals and the second plurality of reference signals comprise DMRSs or PTRSs.
Aspect 10: The method of any of aspects 1 through 9, wherein the first layer comprises a first spatial layer of a MIMO communication scheme and the second layer comprises a second spatial layer of the MIMO communication scheme.
Aspect 11: The method of any of aspects 1 through 10, wherein the first layer comprises a first subband and the second layer comprises a second subband.
Aspect 12: A transmitting device for wireless communications, comprising one or more memories storing processor-executable code, and one or more processors coupled with the one or more memories and individually or collectively operable to execute the code to cause the transmitting device to perform a method of any of aspects 1 through 11.
Aspect 13: A transmitting device for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A transmitting device, comprising:
one or more memories storing processor-executable code; and
one or more processors coupled with the one or more memories and individually or collectively operable to execute the code to cause the transmitting device to:
generate a first set of bits by performing a probabilistic shaping operation on first information bits, the probabilistic shaping operation using a first shaping parameter associated with a first layer;
generate a second set of bits by performing the probabilistic shaping operation on second information bits, the probabilistic shaping operation using a second shaping parameter associated with a second layer to generate the second set of bits, the first shaping parameter being different than the second shaping parameter;
generate a first set of symbols and a second set of symbols by modulating the first set of bits and the second set of bits using a modulation power scaling factor, the first set of symbols corresponding to the first set of bits and the second set of symbols corresponding to the second set of bits; and
transmit the first set of symbols via the first layer and the second set of symbols via the second layer.

2. The transmitting device of claim 1, wherein performing the probabilistic shaping operation on the first information bits results in the first set of symbols having a non-uniformly distributed constellation.

3. The transmitting device of claim 1, wherein the one or more processors are individually or collectively further operable to execute the code to cause the transmitting device to:
receive signaling indicating that the first shaping parameter corresponds to the first layer and the second shaping parameter corresponds to the second layer.

4. The transmitting device of claim 1, wherein, to generate the first set of symbols using the modulation power scaling factor, the one or more processors are individually or collectively operable to execute the code to cause the transmitting device to:
identify the modulation power scaling factor based at least in part on an entropy associated with the first layer being greater than an entropy associated the second layer, wherein the modulation power scaling factor normalizes an average power associated with the first set of symbols for the first layer.

5. The transmitting device of claim 1, wherein, to generate the second set of symbols using the modulation power scaling factor, the one or more processors are individually or collectively operable to execute the code to cause the transmitting device to:
identify the modulation power scaling factor based at least in part on an entropy associated with the second layer being less than an entropy associated with the first layer, wherein the modulation power scaling factor normalize an average power associated with the second set of symbols for the second layer.

6. The transmitting device of claim 1, wherein the modulation power scaling factor normalizes an average power or a summation of power associated with the first set of symbols and the second set of symbols.

7. The transmitting device of claim 1, wherein the modulation power scaling factor is based on a modulation order configured for the transmitting device.

8. The transmitting device of claim 1, wherein the one or more processors are individually or collectively further operable to execute the code to cause the transmitting device to:
transmit a first plurality of reference signals via the first layer using a power level that is based on a power level associated with the first set of symbols; and
transmit a second plurality of reference signals via the second layer using a power level that is based on a power level associated with the second set of symbols.

9. The transmitting device of claim 8, wherein:
the first plurality of reference signals and the second plurality of reference signals comprise demodulation reference signals or phase tracking reference signals.

10. The transmitting device of claim 1, wherein the first layer comprises a first spatial layer of a multiple-input multiple-output communication scheme and the second layer comprises a second spatial layer of the multiple-input multiple-output communication scheme.

11. The transmitting device of claim 1, wherein the first layer comprises a first subband and the second layer comprises a second subband.

12. A method for wireless communications at a transmitting device, comprising:
generating a first set of bits by performing a probabilistic shaping operation on first information bits, the probabilistic shaping operation using a first shaping parameter associated with a first layer;
generating a second set of bits by performing the probabilistic shaping operation on second information bits, the probabilistic shaping operation using a second shaping parameter associated with a second layer to generate the second set of bits, the first shaping parameter being different than the second shaping parameter;
generating a first set of symbols and a second set of symbols by modulating the first set of bits and the second set of bits using a modulation power scaling factor, the first set of symbols corresponding to the first set of bits and the second set of symbols corresponding to the second set of bits; and
transmitting the first set of symbols via the first layer and the second set of symbols via the second layer.

13. The method of claim 12, wherein performing the probabilistic shaping operation on the first information bits results in the first set of symbols having a non-uniformly distributed constellation.

14. The method of claim 12, further comprising:
receiving signaling indicating that the first shaping parameter corresponds to the first layer and the second shaping parameter corresponds to the second layer.

15. The method of claim 12, wherein generating the first set of symbols using the modulation power scaling factor comprises:
identifying the modulation power scaling factor based at least in part on an entropy associated with the first layer being greater than an entropy associated the second layer, wherein the modulation power scaling factor normalizes an average power associated with the first set of symbols for the first layer.

16. The method of claim 12, wherein generating the second set of symbols using the modulation power scaling factor comprises:
identifying the modulation power scaling factor based at least in part on an entropy associated with the second layer being less than an entropy associated with the first layer, wherein the modulation power scaling factor normalize an average power associated with the second set of symbols for the second layer.

17. The method of claim 12, wherein the modulation power scaling factor normalizes an average power or a summation of power associated with the first set of symbols and the second set of symbols.

18. The method of claim 12, wherein the modulation power scaling factor is based on a modulation order configured for the transmitting device.

19. The method of claim 12, further comprising:
transmitting a first plurality of reference signals via the first layer using a power level that is based on a power level associated with the first set of symbols; and
transmitting a second plurality of reference signals via the second layer using a power level that is based on a power level associated with the second set of symbols.

20. The method of claim 19, wherein the first plurality of reference signals and the second plurality of reference signals comprise demodulation reference signals or phase tracking reference signals.

21. The method of claim 12, wherein the first layer comprises a first spatial layer of a multiple-input multiple-output communication scheme and the second layer comprises a second spatial layer of the multiple-input multiple-output communication scheme.

22. The method of claim 12, wherein the first layer comprises a first subband and the second layer comprises a second subband.

23. A non-transitory computer-readable medium storing code for wireless communications, the code comprising instructions executable by one or more processors to:
generate a first set of bits by performing a probabilistic shaping operation on first information bits, the probabilistic shaping operation using a first shaping parameter associated with a first layer;
generate a second set of bits by performing the probabilistic shaping operation on second information bits, the probabilistic shaping operation using a second shaping parameter associated with a second layer to generate the second set of bits, the first shaping parameter being different than the second shaping parameter;
generate a first set of symbols and a second set of symbols by modulating the first set of bits and the second set of bits using a modulation power scaling factor, the first set of symbols corresponding to the first set of bits and the second set of symbols corresponding to the second set of bits; and
transmit the first set of symbols via the first layer and the second set of symbols via the second layer.

24. The non-transitory computer-readable medium of claim 23, wherein the instructions are further executable by the one or more processors to:
receive signaling indicating that the first shaping parameter corresponds to the first layer and the second shaping parameter corresponds to the second layer.

25. The non-transitory computer-readable medium of claim 23, wherein the instructions to generate the first set of symbols using the modulation power scaling factor are executable by the one or more processors to:
identify the modulation power scaling factor based at least in part on an entropy associated with the first layer being greater than an entropy associated the second layer, wherein the modulation power scaling factor normalizes an average power associated with the first set of symbols for the first layer.

26. The non-transitory computer-readable medium of claim 23, wherein the instructions to generate the second set of symbols using the modulation power scaling factor are executable by the one or more processors to:
identify the modulation power scaling factor based at least in part on an entropy associated with the second layer being less than an entropy associated with the first layer, wherein the modulation power scaling factor normalize an average power associated with the second set of symbols for the second layer.

27. A transmitting device for wireless communications, comprising:
means for generating a first set of bits by performing a probabilistic shaping operation on first information bits, the probabilistic shaping operation using a first shaping parameter associated with a first layer;
means for generating a second set of bits by performing the probabilistic shaping operation on second information bits, the probabilistic shaping operation using a second shaping parameter associated with a second layer to generate the second set of bits, the first shaping parameter being different than the second shaping parameter;
means for generating a first set of symbols and a second set of symbols by modulating the first set of bits and the second set of bits using a modulation power scaling factor, the first set of symbols corresponding to the first set of bits and the second set of symbols corresponding to the second set of bits; and
means for transmitting the first set of symbols via the first layer and the second set of symbols via the second layer.

28. The transmitting device of claim 27, further comprising:
means for receiving signaling indicating that the first shaping parameter corresponds to the first layer and the second shaping parameter corresponds to the second layer.

29. The transmitting device of claim 27, wherein the means for generating the first set of symbols using the modulation power scaling factor comprise:
means for identifying the modulation power scaling factor based at least in part on an entropy associated with the first layer being greater than an entropy associated the second layer, wherein the modulation power scaling factor normalizes an average power associated with the first set of symbols for the first layer.

30. The transmitting device of claim 27, wherein the means for generating the second set of symbols using the modulation power scaling factor comprise:
means for identifying the modulation power scaling factor based at least in part on an entropy associated with the second layer being less than an entropy associated with the first layer, wherein the modulation power scaling factor normalize an average power associated with the second set of symbols for the second layer.
